(19) United States
(12) Patent Application Publication
(10) Pub. No.: US 2013/0342548 A1
(43) Pub. Date: Dec. 26, 2013

(54) DISPLAY MODULE AND ELECTRONIC APPARATUS

(71) Applicant: KABUSHIKI KAISHA TOSHIBA, TOKYO (JP)

(72) Inventor: Masashi Mikami, Ome-shi (JP)

(73) Assignee: KABUSHIKI KAISHA TOSHIBA, TOKYO (JP)

(21) Appl. No.: 14/013,928

(22) Filed: Aug. 29, 2013

Related U.S. Application Data
(63) Continuation of application No. PCT/JP2013/057945, filed on Mar. 13, 2013.

(30) Foreign Application Priority Data
May 17, 2012 (JP) 2012-113580

(51) Int. Cl. G09G 5/00

(52) U.S. Cl. CPC G09G 5/005
USPC 345/520

(57) ABSTRACT

According to one embodiment, a display module includes a display unit, a control unit and a ground unit. The display unit includes a circuit and is configured to display an image. The control unit is connected to the display unit, is configured to control the display unit, and includes a first electrically conductive portion. The ground unit is connected to the circuit of the display unit and the first electrically conductive portion of the control unit and configured to ground the circuit of the display unit and the control unit.

### CROSS REFERENCE TO RELATED APPLICATIONS

This application is a Continuation Application of PCT Application No. PCT/JP2013/057945, filed Mar. 13, 2013 and based upon and claiming the benefit of priority from Japanese Patent Application No. 2012-113580, filed May 17, 2012, the entire contents of all of which are incorporated herein by reference.

### FIELD

Embodiments described herein relate generally to a display module and an electronic apparatus.

### BACKGROUND

Display modules, such as liquid-crystal displays (LCDs), organic electroluminescent displays, etc., are grounded to suppress noise. For example, a metal bezel is used to ground the display modules.

The bezel increases the rigidity of the display modules. Therefore, some flexible display modules do not use a bezel. Thus, it requires some improvement to ground components of the display modules.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary exploded perspective view of a television according to a first embodiment;

FIG. 2 is an exemplary plan view showing part of a display module of the first embodiment;

FIG. 3 is an exemplary sectional view of the display module of the first embodiment taken along line F3-F3 of FIG. 2;

FIG. 4 is an exemplary sectional view showing part of a display module according to a second embodiment; and

FIG. 5 is an exemplary sectional view showing part of a display module according to a third embodiment.

### DETAILED DESCRIPTION

Various embodiments will be described hereinafter with reference to the accompanying drawings.

In general, according to one embodiment, a display module includes a display unit, a control unit and a ground unit. The display unit includes a circuit and is configured to display an image. The control unit is connected to the display unit, is configured to control the display unit, and includes a first electrically conductive portion. The ground unit is connected to the circuit of the display unit and the first electrically conductive portion of the control unit and configured to ground the circuit of the display unit and the control unit.

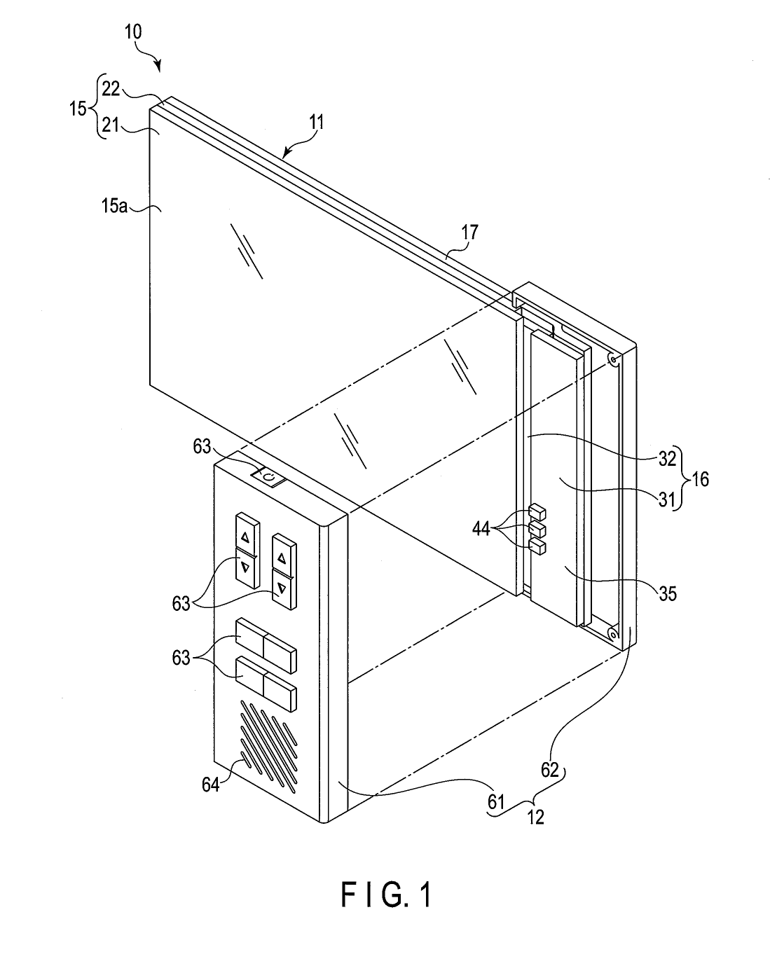

A first embodiment will now be described with reference to FIGS. 1 to 3. In this specification, the near or user side is defined as forward; the far side from the user as rearward, the user's left-hand side as leftward, the user's right-hand side as rightward, and the upper and lower sides with respect to the user as upward and downward, respectively. Further, each element that can be expressed in different ways may sometimes be represented by one or more alternative examples of expressions. However, this neither denies that an element that is not given any alternative expression can be differently expressed, nor restricts other expressions that are not exemplified.

FIG. 1 is an exemplary exploded perspective view of a television reception apparatus (television) 10 according to the first embodiment. The television 10 is an example of an electronic apparatus. The electronic apparatus is not limited to this and may be one of various other components, such as a portable computer, tablet computer, personal digital assistant (PDA), cellphone, digital photoframe, camera, etc.

The television 10 according to the present embodiment is, for example, a small portable television. The television 10 comprises a display module 11 and housing 12. The display module 11 can be alternatively expressed as, for example, a display, component, or display device. The housing 12 can be alternatively expressed as, for example, a casing, shell, or wall portion.

The display module 11 of the present embodiment is, for example, a flexible-plastic organic electroluminescent (POEL) display that is freely bendable. For example, the display module 11 can be wound in a cylindrical shape. The display module 11 is not limited to this configuration and may alternatively be a rigid organic electroluminescent display or one of various other modules, such as a liquid-crystal display, electronic paper display, etc.

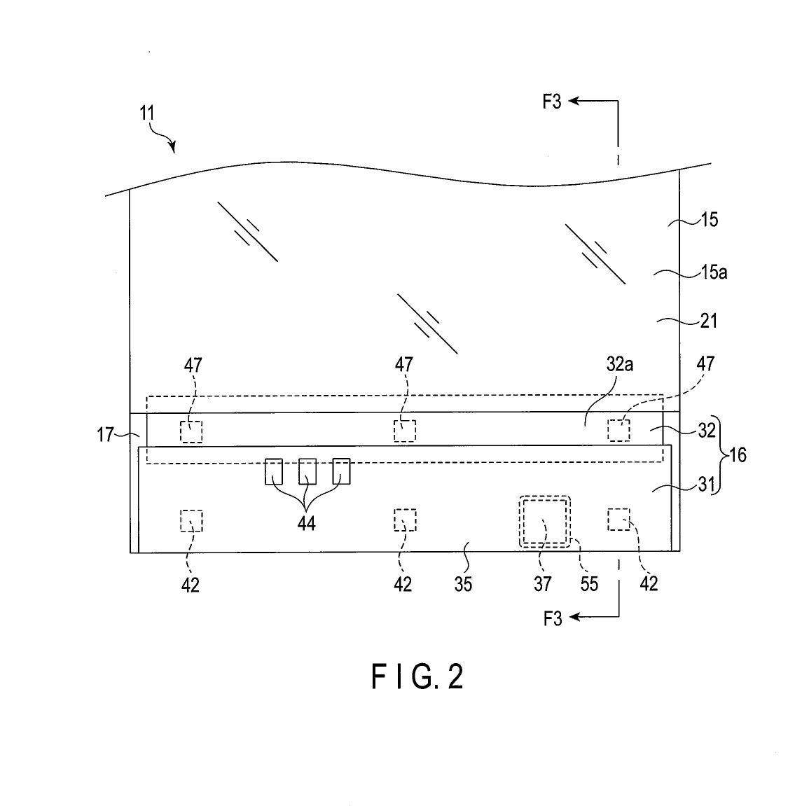

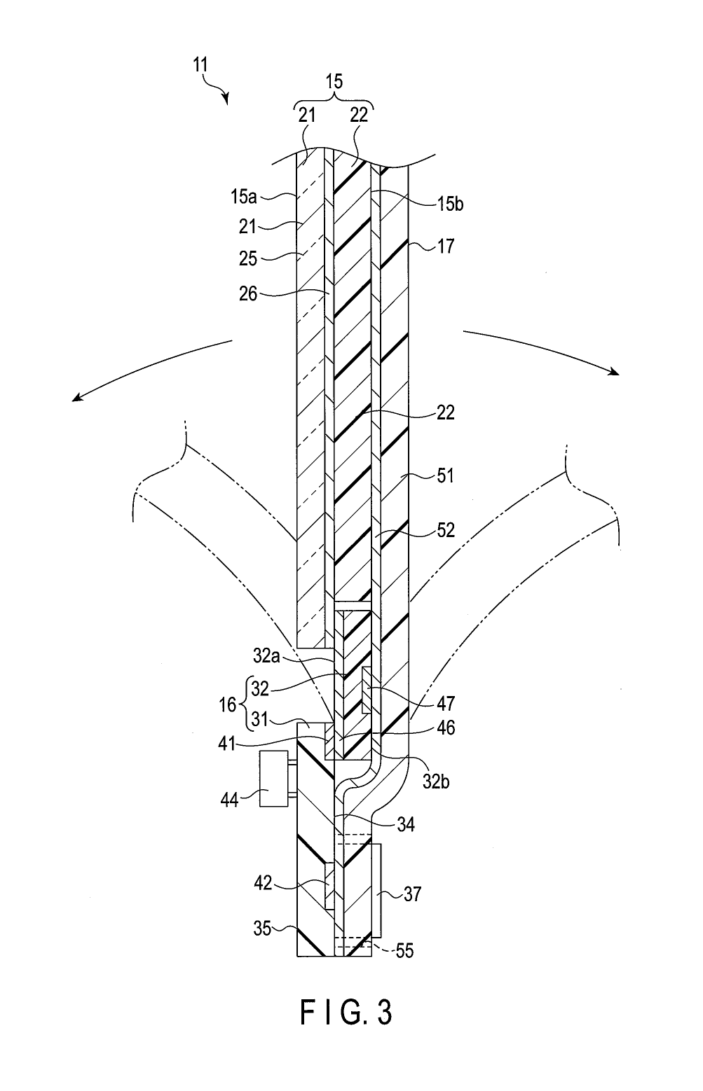

FIG. 2 is an exemplary plan view showing part of the display module 11. FIG. 3 is an exemplary partial sectional view of the display module 11 taken along line F3-F3 of FIG. 2. As shown in FIG. 3, the display module 11 comprises a display unit 15, control unit 16, and ground unit 17.

The display unit 15 comprises an electrode layer 21 and light-emitting layer 22. The electrode layer 21 can be alternatively expressed as, for example, a cover, circuit portion, electrode portion, or display portion. The light-emitting layer 22 can be alternatively expressed as a light-emitting portion, circuit portion, or image forming portion.

The electrode layer 21 comprises a transparent resin film 25 and transparent first electrode 26. The film 25 is rectangular. The first electrode 26 is, for example, a trace pattern formed on one surface of the film 25 by vapor deposition. The first electrode 26 serves as a cathode of an organic electroluminescent device. Since both the film 25 and the first electrode 26 are flexible, the electrode layer 21 can be bent freely.

The light-emitting layer 22 comprises a plurality of pixels. Each pixel is formed from an organic compound and trace pattern. This organic compound corresponds to the first electrode 26 of the electrode layer 21. The organic compound is interposed between the first electrode 26 and an anode on the trace pattern of the light-emitting layer 22.

The electrode layer 21 is laminated to the light-emitting layer 22. The first electrode 26 of the electrode layer 21 is in contact with the light-emitting layer 22.

Since the light-emitting layer 22 is flexible, it can be bent freely. Thus, the display unit 15 that is formed by laminating the electrode layer 21 and light-emitting layer 22 is flexible and freely bendable. The display unit 15 may be formed to comprise other parts than the electrode layer 21 and light-emitting layer 22.

In the display unit 15, current is passed between the first electrode 26 of the electrode layer 21 and the anode of the trace pattern of the light-emitting layer 22, whereupon the organic compound of the light-emitting layer 22 glows. In other words, luminescence occurs in the organic compound of the light-emitting layer 22. In this way, the display unit 15 displays an image. As described above, the display unit 15 uses organic electroluminescence for image display.

The control unit 16 comprises a control board 31 and junction 32. The control board 31 can be alternatively expressed as, for example, a board, control portion, or mounted portion. The junction 32 can be alternatively expressed as, for example, a cable, intermediate portion, or interposed portion.

The control board 31 is, for example, a rigid printed circuit board. However, the control board 31 is not limited to this and may be another board, such as a flexible printed circuit board. As shown in FIG. 2, the control board 31 is rectangular.

As shown in FIG. 3, the control board 31 comprises first and second mounted surfaces 34 and 35. The second mounted surface 35 is located opposite to the first mounted surface 34. The first mounted surface 34 is an example of a covered surface.

A first electronic component 37, such as a ball grid array (BGA), is mounted on the first mounted surface 34. The first electronic component 37 processes, for example, data on an image displayed on the display unit 15. Another component, such as a capacitor, may be mounted on the first mounted surface 34.

A plurality of third electrodes 41 and a plurality of fourth electrodes 42 are disposed on the first mounted surface 34. The fourth electrodes 42 are an example of electrically conductive portions and first electrically conductive portions. The third electrodes 41 are arranged side by side on an end portion of the first mounted surface 34. As shown in FIG. 2, the fourth electrodes 42 are arranged longitudinally relative to the control board 31.

A plurality of second electronic components 44, such as capacitors, are mounted on the second mounted surface 35. The second electronic components 44 may be various other components, such as ICs.

Further, various components, such as an antenna, tuner, speaker, switch, and battery, are mounted on or connected to the control board 31. Another board mounted with these various components may be connected to the control board 31.

The junction 32 is, for example, a flexible printed circuit board. The junction 32 is not limited to this and may be one of various other components, such as a cable. The junction 32 is flexible and freely bendable.

As shown in FIG. 3, a trace pattern 46 is formed on a first surface 32a of the junction 32. The trace pattern 46 is formed ranging from one end portion of the junction 32 to the other end portion. One end portion of the trace pattern 46 is connected to the electrode layer 21 of the display unit 15 by thermocompressive bonding. The other end portion of the trace pattern 46 is connected to the third electrodes 41 on the control board 31 by thermocompressive bonding. Further, fifth electrodes 47 are disposed on a second surface 32b of the junction 32. The fifth electrodes 47 are an example of second electrically conductive portions.

The third electrodes 41 on the control board 31 are electrically connected to the first electrode 26 of the electrode layer 21 through the trace pattern 46 of the junction 32. In other words, the junction 32 connects the control board 31 to the display unit 15. The junction 32 may be connected to another part of the display unit 15 in place of the first electrode 26.

The control unit 16 processes, for example, image data acquired through the antenna and tuner and transmits an electrical signal to the display unit 15. On receiving the electrical signal, the display unit 15 displays an image based on the image data processed by the control unit 16. Thus, the control unit 16 controls the display unit 15 to display an image thereon.

The ground unit 17 comprises a base film 51 and ground pattern 52. The base film 51 can be alternatively expressed as, for example, a film, base part, or cover part.

The base film 51 is a rectangular resin film. The base film 51 is larger than the display unit 15 and control unit 16 that are connected to each other. In other words, the base film 51 can conceal the two connected units 15 and 16. The base film 51 may alternatively be as large as or smaller than the display unit 15 and control unit 16.

The ground pattern 52 is an electrically conductive pattern formed by vapor deposition on one surface of the base film 51. Since both the base film 51 and the ground pattern 52 are flexible, the ground unit 17 can be bent freely.

The ground unit 17 is laminated to the display unit 15 that comprises first and second surfaces 15a and 15b. The second surface 15b of the display unit 15 is located opposite to the first surface 15a. As described before, an image is displayed on the first surface 15a of the display unit 15. The ground unit 17 is arranged on the second surface 15b of the display unit 15.

As described above, both the display unit 15 and the ground unit 17 are flexible and freely bendable. Thus, the combination of the display and ground units 15 and 17 superposed on each other is flexible and freely bendable.

For ease of understanding, according to the present embodiment, the display unit 15 and ground unit 17 are described as being separate components. Alternatively, however, the display unit 15 and ground unit 17 may be formed as a single integral component. In the case of the integral component comprising the display unit 15 and ground unit 17, the trace pattern of the light-emitting layer 22 is connected to the ground pattern 52 by one of various methods.

While the ground unit 17 covers the first mounted surface 34 of the control board 31, only part of the first mounted surface 34 may be covered by the ground unit 17. The fourth electrodes 42 on the control board 31 are connected to the ground pattern 52 of the ground unit 17 by thermocompressive bonding. Thus, the control board 31 is grounded by the ground pattern 52.

The ground unit 17 comprises an opening 55. The opening 55 is a hole that penetrates the base film 51 and ground pattern 52. Alternatively, the opening 55 may be, for example, a notch.

The opening 55 is formed to make room for the first electronic component 37. In other words, the opening 55 surrounds that region of the first mounted surface 34 of the control board 31 on which the first electronic component 37 is disposed. This region of the first mounted surface 34 is exposed through the opening 55.

Further, the ground unit 17 covers the second surface 32b of the junction 32. The fifth electrodes 47 on the junction 32 are connected to the ground pattern 52 of the ground unit 17 by thermocompressive bonding. Thus, the junction 32 is grounded by the ground pattern 52.

As shown in FIG. 1, part of the display module 11 described above is accommodated in the housing 12. Specifically, part of the display unit 15, the control unit 16, and part of the ground unit 17 are accommodated in the housing 12.

That part of the display module 11 which is located outside the housing 12 is flexible and freely bendable. Therefore, it can be wound around the housing 12, for example.

The housing 12 comprises front and rear covers 61 and 62. The first cover 61 comprises a plurality of buttons 63 and sound outlets 64. The buttons 63 activate switches that are mounted on or connected to the control board 31. Sound produced by the speaker, which is mounted on or connected to the control board 31, is emitted through the sound outlets 64.

According to the television 10 constructed in this manner, the ground pattern 52 of the ground unit 17 is connected to the fourth electrodes 42 on the control board 31 and the fifth electrodes 47 on the junction 32. Thus, the trace pattern of the display unit 15 and the control unit 16 are grounded by the ground pattern 52.

When an electrical signal is transmitted from the control unit 16 to the display unit 15, therefore, current returns through the ground unit 17. Thus, a path through which the drive current returns is simplified, so that noise can be suppressed.

Since the display unit 15 and control unit 16 are grounded by the common ground pattern 52, moreover, their respective reference potentials are equal. In other words, the potential difference between the respective grounds of the display unit 15 and control unit 16 is zero. Thus, voltage is stabilized, so that noise can be suppressed.

Both the display unit 15 and the ground unit 17 that are connected to each other are freely bendable. Thus, the display module 11 can be freely deformed, for example, wound or bent. The portability of the television 10 can be improved by, for example, winding the display module 11 around the housing 12.

The ground unit 17 is arranged on the second surface 15b of the display unit 15 and covers the control board 31 and junction 32 of the control unit 16. Specifically, the ground unit 17 can be formed by extending a layer for grounding the display unit 15, so that an increase in the manufacturing cost of the display module 11 can be suppressed. Further, the control unit 16 is protected by being covered by the ground unit 17.

The trace pattern of the display unit 15, control board 31, and junction 32 are all grounded by the ground pattern 52 of the ground unit 17. Therefore, the path through which current passed from the control board 31 to the junction 32 and display unit 15 returns is simplified. Further, the reference potential of the display unit 15 is equal to those of the control board 31 and junction 32. Thus, noise from the display module 11 can be suppressed.

The ground unit 17 comprises the opening 55 that makes room for the first electronic component 37. Thus, the component can be mounted on the first mounted surface 34 of the control board 31 that is covered by the ground unit 17. In this way, the design flexibility of the display module 11 is improved.

The trace pattern 46 of the junction 32 is connected to the display unit 15 by thermocompressive bonding. Further, the fourth electrodes 42 on the control board 31 and the fifth electrodes 47 on the junction 32 are all connected to the ground pattern 52 by thermocompressive bonding. Thus, the method of connecting the control unit 16 and display unit 15 is identical to the method of connecting the ground pattern 52 to the fourth and fifth electrodes 42 and 47. In this way, an increase in the manufacturing cost of the display module 11 can be suppressed.

The method of connecting the ground pattern 52 to the fourth and fifth electrodes 42 and 47 is not limited to thermocompressive bonding. Alternatively, the ground pattern 52 may be connected to the fourth and fifth electrodes 42 and 47 by, for example, soldering, bonding with an electrically conductive adhesive or double-sided tape, or direct contacting.

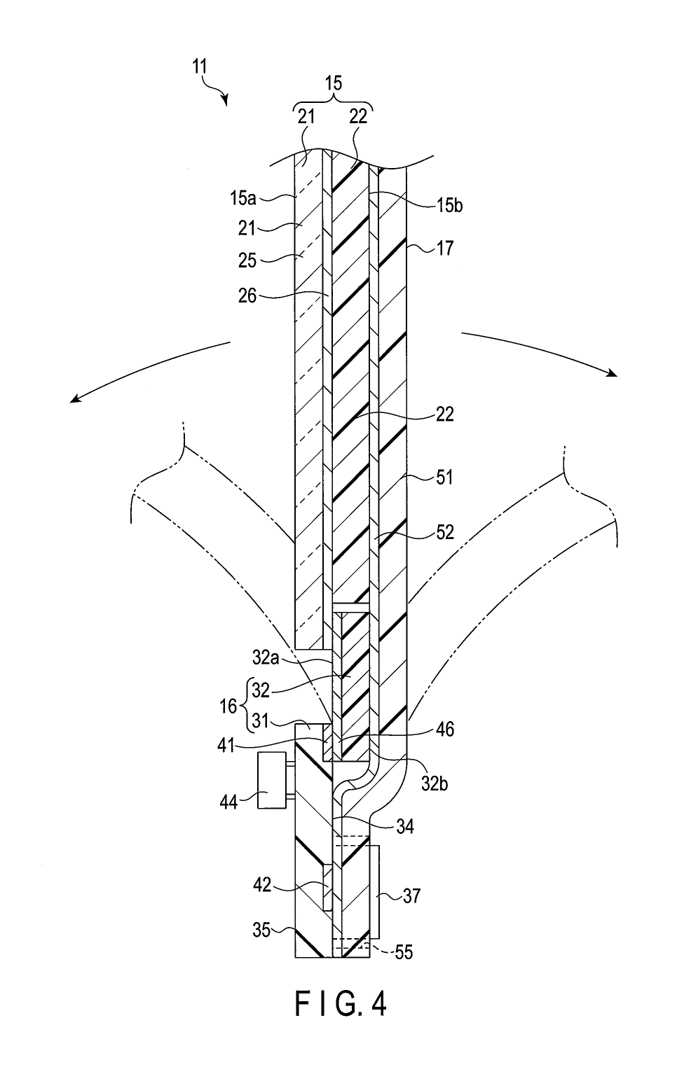

A second embodiment will now be described with reference to FIG. 4. In the description of at least one of the embodiments to follow, like reference numbers are used to designate like constituent parts having the same functions as those of the television 10 of the first embodiment. Further, a description of those constituent parts may be partially or entirely omitted.

FIG. 4 is an exemplary sectional view showing part of a display module 11 of a television 10 according to the second embodiment. As shown in FIG. 4, a junction 32, unlike that of the first embodiment, is not grounded by a ground pattern 52.

According to the television 10 constructed in this manner, the ground pattern 52 is connected to the control board 31 but not to the junction 32. Thus, the cost of connecting the ground pattern 52 and junction 32 can be reduced.

Both the display unit 15 and the control board 31 are grounded by the ground pattern 52, though the junction 32 is not. Thus, noise from the display module 11 can be suppressed.

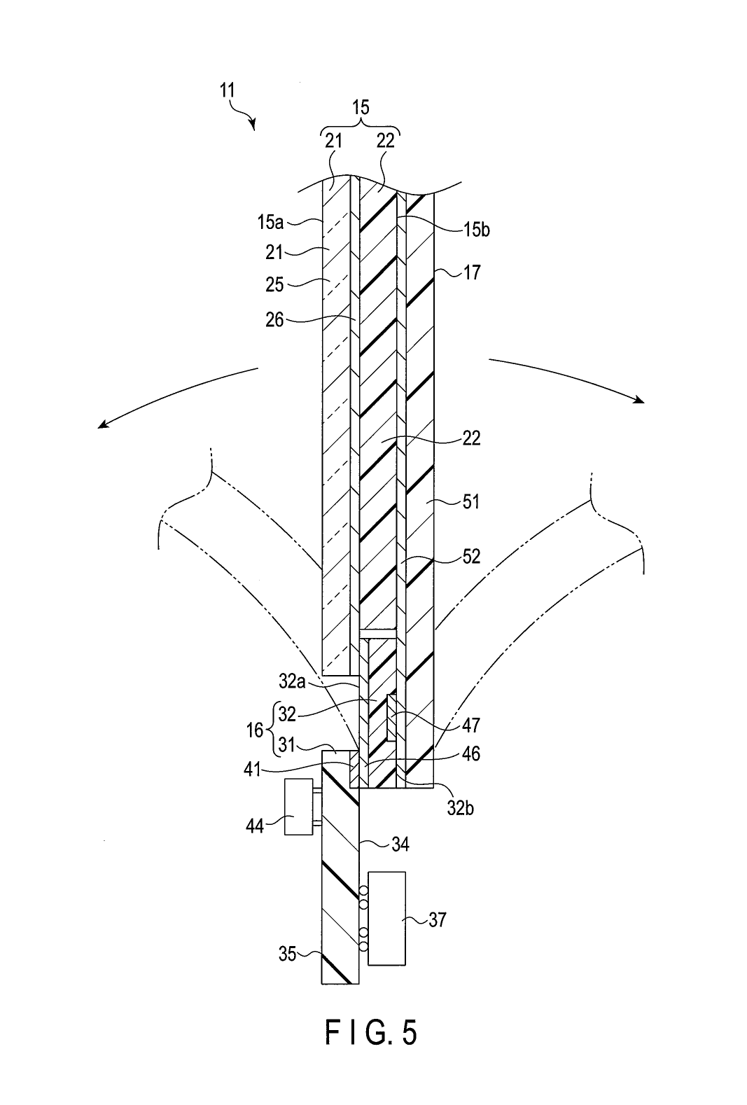

A third embodiment will now be described with reference to FIG. 5. FIG. 5 is an exemplary sectional view showing part of a display module 11 of a television 10 according to the third embodiment. As shown in FIG. 5, a ground unit 17 covers a junction 32 of a control unit 16 and does not cover a control board 31. In other words, the control board 31 is not grounded by a ground pattern 52. In the third embodiment, a fifth electrode 47 is an example of an electrically conductive portion.

According to the television 10 constructed in this manner, the ground pattern 52 is connected to the junction 32 but not to the control board 31. Thus, the cost of connecting the ground pattern 52 and control board 31 can be reduced.

Both the display unit 15 and the junction 32 are grounded by the ground unit 17, though the control board 31 is not grounded by the ground pattern 52. Thus, noise from the display module 11 can be suppressed.

Further, the control board 31 is not covered by the ground unit 17. Therefore, the ground unit 17 of the present embodiment is shorter than that of the first embodiment. Thus, the material cost of the ground unit 17 can be reduced.

According to the display module and electronic apparatus of at least one of the embodiments described above, the ground unit is connected to the circuit of the display unit and the electrically conductive portion of the control unit, and the circuit of the display unit and the control unit are grounded. In this way, noise can be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the embodiments described herein, for example, the control unit 16 comprises the control board 31, which is a rigid printed circuit board, and the junction 32, which is a flexible printed circuit board. However, the control unit is not limited to this and may be formed of, for example, a single flexible printed circuit board. Further, the display unit 15 may be a touch panel.

What is claimed is:

1. A display module comprising:
a display unit comprising a circuit and configured to display an image;
a control unit configured to connect to the display unit, configured to control the display unit, and comprising a first electrically conductive portion; and
a ground unit configured to connect to the circuit of the display unit and to the first electrically conductive portion of the control unit and configured to ground the circuit of the display unit and the control unit.

2. The display module of claim 1, wherein both the display unit and the ground unit are freely bendable.

3. The display module of claim 2, wherein the display unit comprises a first surface configured to display the image and a second surface opposite to the first surface, and the ground unit is on the second surface of the display unit and is configured to cover at least a part of the control unit.

4. The display module of claim 3, wherein the control unit comprises a control board comprising an electronic component and the first electrically conductive portion, and a junction comprising a second electrically conductive portion configured to connect to the ground unit and configured to connect the control board to the display unit.

5. The display module of claim 3, wherein the control unit comprises a control board comprising an electronic component and comprising the first electrically conductive portion and a junction configured to connect the control board to the display unit.

6. The display module of claim 3, wherein the control unit comprises a control board comprising an electronic component and a junction comprising the first electrically conductive portion and configured to connect the control board to the display unit.

7. The display module of claim 4, wherein the control board comprises a covered surface comprising the electronic component and at least partially covered by the ground unit, and the ground unit comprises an opening for the electronic component and exposing the covered surface of the control board.

8. The display module of claim 5, wherein the control board comprises a covered surface comprising the electronic component and at least partially covered by the ground unit, and the ground unit comprises an opening for the electronic component and exposing the covered surface of the control board.

9. The display module of claim 7, wherein the control unit is configured to connect to the display unit by thermocompressive bonding, and the ground unit is configured to connect to the first electrically conductive portion of the control unit by thermocompressive bonding.

10. The display module of claim 8, wherein the control unit is configured to connect to the display unit by thermocompressive bonding, and the ground unit is configured to connect to the first electrically conductive portion of the control unit by thermocompressive bonding.

11. The display module of claim 9, wherein the display unit is configured to display the image by means of organic electroluminescence.

12. The display module of claim 10, wherein the display unit is configured to display the image by means of organic electroluminescence.

13. An electronic apparatus comprising:
a housing;
a display unit comprising a circuit and configured to display an image;
a control unit in the housing, configured to connect to the display unit, configured to control the display unit, and comprising an electrically conductive portion; and
a ground unit configured to connect to the circuit of the display unit and to the electrically conductive portion of the control unit and configured to ground the circuit of the display unit and the control unit.
